(19) United States
(12) Patent Application Publication
(10) Pub. No.: US 2013/0324444 A1
(43) Pub. Date: Dec. 5, 2013

(54) SYSTEM AND METHOD FOR DELIVERING TREATMENT FLUID

(71) Applicants: Timothy Lesko, Sugar Land, TX (US); Edward Leugemors, Needville, TX (US); Rod Shampine, Houston, TX (US); Theodore Lafferty, Sugar Land, TX (US); Anthony Loiseau, Sugar Land, TX (US)

(72) Inventors: Timothy Lesko, Sugar Land, TX (US); Edward Leugemors, Needville, TX (US); Rod Shampine, Houston, TX (US); Theodore Lafferty, Sugar Land, TX (US); Anthony Loiseau, Sugar Land, TX (US)

(21) Appl. No.: 13/487,002

(22) Filed: Jun. 1, 2012

(51) Int. Cl. C09K 8/62; C04B 7/00; G05D 11/00

(52) U.S. Cl. 507/206; 507/200; 137/87.01; 507/211; 507/266; 507/261; 507/219; 507/232; 507/269; 507/274; 106/638

(57) ABSTRACT

The current application discloses methods and systems for preparing a wellbore treatment fluid precursor consolidated as one or more solid bodies; delivering the solid bodies to a logistics facility; and preparing a wellbore treatment fluid from the solid bodies. In some embodiments, the wellbore treatment fluid is a fracturing fluid for conducting a hydraulic fracturing operation on a subterranean formation penetrated by a wellbore.

### BACKGROUND

The statements in this section merely provide background information related to the present disclosure and may not constitute prior art.

The technical field generally, but not exclusively, relates to the treatment of wellbores in the oil and gas industry. Presently known techniques include providing bulk continuous phase fluids to the wellbore surface location, and mixing and/or hydrating the prepared treatment fluid at the surface location. The fluids take significant time to prepare, and require precise measurement, at least with respect to certain particles and additives, to ensure the proper formulation. Certain additives or materials in the fluid will cause fluid failure and/or needlessly increase the expense of the fluid if added in improper or imprecise amounts. The equipment to ensure that the prepared treatment fluid is properly prepared is expensive and not readily mobile, increasing the expense of the treatment or reducing the quality of the prepared fluid.

Certain previously known techniques require the separate delivery of both the liquid and solid portions of the treatment fluid to the surface location, reducing the transport capacity of a wellsite delivery vessel in terms of final treatment fluid equivalent amounts. Certain previously known techniques require addition of proppant at the surface location, requiring additional equipment at the surface location including at least a proppant delivery unit (a, sand truck, proppant hopper, Sand Chief, Sand King, Mountain Mover, etc.) and a liquid-solid mixing vehicle (e.g., a frac blender and/or POD blender). Certain previously known techniques also create a prepared fluid having a very limited shelf life, requiring careful job planning to ensure that fluids do not run short, or requiring that excess fluids be discarded. Accordingly, further technological developments are desirable in this area.

The current application addresses one or more of the problems associated with the currently known operations.

### SUMMARY

In certain embodiments, a method is disclosed including operations to prepare a wellbore treatment fluid precursor having a solid particle species and an additive. The method includes an operation to consolidate the wellbore treatment fluid precursor into a number of solid bodies, each of the solid bodies having a substantially similar average composition. The method may include an operation to add a binding agent to the wellbore treatment fluid precursor before the consolidating. The method may include an operation to form a wellbore treatment fluid, where the forming operation includes adding the solid bodies to a carrier fluid, and providing the wellbore treatment fluid to a high pressure pump fluidly coupled to a wellbore, and may further include reducing a dimension of the added solid bodies, measuring an amount of the added solid bodies, and/or dissolving one of the solid particle species. The method may include forming the wellbore treatment fluid by independently dispersing a solid particle species product and an additive product into the wellbore treatment fluid, where the solid particle species product includes the solid particle species and/or a solid particle species successor, and where the additive product includes the additive and/or an additive successor. The method may include forming a concentrated wellbore treatment fluid by adding the solid bodies to an amount of a carrier fluid, and may further include forming a wellbore treatment fluid by adding an additional amount of the carrier fluid to the concentrated wellbore treatment fluid, and may still further include transporting the concentrated wellbore treatment fluid from a logistics facility to a surface location for a wellbore. The method may include forming a wellbore treatment fluid after an intermediate storage time elapses.

In certain embodiments, an article of manufacture is disclosed. The article of manufacture includes a number of solid bodies, each of the solid bodies having a substantially similar average composition, and each of the solid bodies having a solid particle species for treating a subterranean formation and an additive, where the solid particle species and the additive are present in a defined ratio therebetween. The article of manufacture may further include a binding agent, and/or may include each of the solid bodies being fully suspensible in a carrier fluid.

In certain embodiments, a system is disclosed including a solid particle species source for treating a subterranean formation and an additive source. The system further includes a binding agent source, a mixing vessel operationally coupled to the sources that provides a mixed particle effluent, and a consolidation device that receives the mixed particle effluent and consolidates the mixed particle effluent into a number of solid bodies each having a substantially similar average composition. The system may include a reconstituting device that mixes a carrier fluid with the number of solid bodies and provides a pump ready treatment fluid. The system may further include the consolidation device positioned at a production facility and the reconstituting device positioned at a logistics facility or a wellsite. The reconstituting device, where present, may mix a releasing agent with the carrier fluid and the solid bodies.

### BRIEF DESCRIPTION OF THE DRAWINGS

These and other features and advantages will be better understood by reference to the following detailed description when considered in conjunction with the accompanying drawings.

FIG. 1 is a schematic representation of a number of solid bodies including at least one solid particle species and a binding agent.

FIG. 2 is a schematic representation of a system for providing a consolidated wellbore treatment fluid precursor.

FIG. 3 is a schematic representation of a reconstituting device.

FIG. 4 is a schematic representation of a production facility, a logistics facility and a number of wellsites.

FIG. 5 is a schematic representation of a system including a reconstituting device.

### DETAILED DESCRIPTION OF SOME ILLUSTRATIVE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

The schematic flow descriptions which follow provide illustrative embodiments of performing procedures for preparing consolidated wellbore treatment fluid precursors. Operations illustrated are understood to be examples only, and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

In particular, it should be understood that, although a substantial portion of the following detailed description is provided in the context of oilfield hydraulic fracturing operations, other oilfield operations such as cementing, gravel packing, workover operations, etc., can utilize and benefit from the disclosure of the current application as well. All variations that can be readily perceived by people skilled in the art having the benefit of the current application should be considered as within the scope of the current application.

As used herein, the term “wellbore treatment fluid precursor” should be understood broadly. A wellbore treatment fluid includes at least two materials present in a predetermined ratio such that, with the addition of a fluid phase and potentially one or more additives, can be made to form a wellbore treatment fluid. The formation of the wellbore treatment fluid may additionally or alternatively include, without limitation, addition of clay stabilizers, biocides, viscosifying agents, breakers, immiscible materials such as proppant, and/or proppant flowback control additives. The wellbore treatment fluid formed that includes the wellbore treatment fluid precursor may include either or both of the two materials in solution, present as an immiscible material, and/or may include a product formed from a degradation, hydrolysis, hydration, chemical reaction, or other process that occurs in response to the addition of the wellbore treatment fluid precursor into the fluid phase and/or other additives.

The term “successor” should be understood broadly. A “successor” is a subsequent material occurring in response to a precursor material. The successor material may be the same material as the precursor material—such as an additive consolidated within a solid body that reconstitutes to the same material after being reformulated into a wellbore treatment fluid. Other example and non-limiting successor materials include reaction products, hydrolysis produces, rehydration products, materials released by an encapsulated precursor, and/or materials resulting from time, temperature, solvent and/or shear degradation of a precursor material. Any material intended to result from a precursor material in response to consolidation and reconstitution of a wellbore treatment fluid may be a successor material.

The term “independently dispersed” should be understood broadly. Independent dispersal indicates that two materials substantially separate and disperse into a treatment fluid independently. However, dispersal of one material may be a part of the process of dispersing a second material—for example where a first material is a surfactant additive designed to assist in dispersal of a second material. The dispersal is still independent, as the first and second materials separate into the treatment fluid.

The term “substantially similar average composition” should be understood broadly. A substantially similar average composition indicates that each solid body of a given formulation is sufficiently consistent to be interchangeable with respect to composition such that the fluid properties of the resulting treatment fluid will achieve the intended design criteria. For example, where fifty solid bodies (or a given bulk volume of solid bodies, and/or a given weight of solid bodies) are added at five solid bodies per barrel of treatment fluid in a 2 ppg (pounds per gallon) fracturing stage, and where the solid bodies include the wellbore treatment fluid viscosifying agent and the proppant, a substantially similar average composition indicates that any given five solid bodies of the fifty solid bodies will produce a treatment fluid having 2 ppg within an acceptable tolerance and having a fluid viscosity within a tolerance level sufficient for the treatment design.

One of skill in the art will recognize, having the benefit of the disclosures herein, that the required tolerances to be a substantially similar average composition for a given fluid depend upon the type of treatment, the purpose of the fluid in the treatment, the sensitivity of the wellbore, formation being treated, and/or equipment involved in the treatment process, and other factors generally known for a given treatment. The production facility for the solid bodies can be configured to provide solid bodies having an arbitrary degree of statistical precision and accuracy in the formulation of the solid bodies. For example, solid bodies having a substantially similar average composition may have not greater than a 0.1% compositional difference, not greater than a 1% compositional difference, not greater than a 5% compositional difference, not greater than a 10% compositional difference, and/or not greater than a 25% compositional difference. A compositional difference can apply to one or more individual constituents of a solid body, and/or to an aggregate description or aggregated correlation parameter of the overall solid body. The described compositional differences are examples, and a particular application may require greater precision than a maximum 0.1% compositional difference or may allow lower precision than a maximum 25% compositional difference, as will be understood to one of skill in the art contemplating a particular application for the treatment fluid having generally known information for the application and the benefit of the disclosures herein. Accordingly, it is a mechanical step for one of skill in the art, having the benefit of the disclosures herein, to determine a sufficient degree of equivalency that is a substantially similar average composition for the solid bodies in a given application.

The term “wellbore treatment fluid” should be understood broadly. Treatment fluids include liquid, a solid, a gas and combinations thereof, as will be appreciated by those skilled in the art. A treatment fluid may take the form of a solution, an emulsion, a slurry or any other form as will be appreciated by those skilled in the art. In some embodiments, the treatment fluid may include a carrier fluid and a substance that is substantially immiscible therein. The carrier fluid may be any matter that is substantially continuous under a given condition. Examples of the carrier fluid include, but are not limited to, water, hydrocarbon, gas, liquefied gas, etc. In some embodiments, the carrier fluid may optionally include a viscosifying agent and/or a portion of the total amount of viscosifying agent present. Some non-limiting examples of the carrier fluid include hydratable gels (e.g., guars, poly-saccharides, xanthan, diutan, hydroxy-ethyl-cellulose, etc.), a cross-linked hydratable gel, a viscosified acid (e.g., gel-based), an emulsified acid (e.g., oil outer phase), an energized fluid (e.g., an N2 or CO2 based foam), a viscoelastic surfactant (VES) viscosified fluid, and an oil-based fluid including a gelled, foamed, or otherwise viscosified oil. Additionally, the carrier fluid may be a brine and/or may include a brine. In certain embodiments, various portions of the carrier fluid, such as but not limited to the viscosifying agent, may be provided to the wellbore treatment fluid through the reconstitution of the solid bodies into the carrier fluid. The substantially immiscible substance can be any matter that only dissolves or otherwise becomes a constituent portion of the carrying fluid under a given condition for less than 10%, sometimes less than 20%, of the weight of substance when it is not in contact of the carrier fluid. Examples of substantially immiscible substance include, but are not limited to, proppant, salt, emulsified hydrocarbon droplets, etc.

As used herein, the terms “solid body” and “solid bodies” should be understood broadly. A solid body includes any material that maintains substantially the same shape over a predetermined shelf life of the solid body, and/or that includes chemicals in a stable (e.g., unreactive or sufficiently slowly reactive) condition. The predetermined shelf life depends upon the specific application and materials in the solid bodies, and will be known to one of skill in the art, having the benefit of the present disclosure, according to information generally known for the particular application. In certain embodiments, a shelf life of 24 hours may be sufficient, and a solid body that generally maintains shape and chemical inertness for that period is sufficient. In certain embodiments, a predetermined shelf life may be one week, one month, one year or a longer period. A shape that is substantially the same shape, without limitation, includes a shape that can be maintained in a similar holding vessel before and after any change, a shape that can be easily recognized and counted as a unit shape before and after any change, and/or a shape that can be delivered to a reconstituting device in the nominal fashion for the specific application before and after any change. One of skill in the art will recognize that a particular amount of shape change that nevertheless meets the purposes of one application (such as storage, quantification, and/or delivery) may be insubstantial for that application, but may be a substantial amount of change for a distinct application because the purposes of the distinct application are not met. Certain handling procedures for the solid bodies may be understood to be required in certain circumstances—for example and without limitation—holding the solid bodies within certain temperature ranges, protecting the solid bodies from light, limiting a vibration or shock profile experienced by the solid bodies, and/or keeping the solid bodies dry, as will be understood according to the specific application and materials present in the solid bodies.

As used herein, the term “treatment slurry” should be understood broadly. A treatment slurry includes any wellbore treatment fluid having at least one substantially immiscible substance therein.

As used herein, the term “concentrated wellbore treatment fluid” should be understood broadly. A concentrated wellbore treatment fluid includes any fluid with at least a portion of an amount of a carrier fluid for a wellbore treatment fluid and a number of reconstituted solid bodies therein. The completion of a wellbore treatment fluid from a concentrated wellbore treatment fluid includes one or more of the operations including adding a carrier fluid to the concentrated wellbore treatment fluid (including a further amount of the same carrier fluid and/or a distinct carrier fluid), and/or adding one or more additives to the concentrated wellbore treatment fluid. In certain embodiments, without limitation, the concentrated wellbore treatment fluid includes a sufficient amount of a carrier fluid to provide any hydration, chemical reactions, dissolution and/or hydrolysis of one or more of the solid particle species from the solid bodies. In certain embodiments, without limitation, the concentrated wellbore treatment fluid includes a sufficient amount of a releasing agent that allows a breakdown of the binding agent and the free mixing of the solid particle species from the solid bodies into the concentrated wellbore treatment fluid.

As used herein, the term “logistics facility” should be understood broadly. In certain embodiments, a logistics facility is any location wherein solid bodies may be stored, reconstituted and/or partially reconstituted between a consolidation location and a wellsite location. A logistics facility can be positioned at a distance from a group of wellsites, sometimes more than 250 miles away, sometimes more than 100 miles away, and sometimes more than 50 miles away. Such a logistics facility may enhance logistical delivery of solid bodies and/or concentrated wellbore treatment fluid to a number of wellsites. In some other embodiments, the logistics facility may be positioned in a field among wellsites. Other example logistics facilities may be positioned near a single wellsite—for example on or near a remote location such as an offshore platform, on or near a pad for access to multiple wells from a single surface location, etc. Additionally or alternatively, an example logistics facility can be positioned incrementally closer to one or more wellsites than a base facility (or facilities) for treating equipment utilized to treat wells at the wellsite(s), and/or closer to one or more wellsites than a production facility that includes the consolidation device preparing the solid bodies. Yet another example logistics facility is positioned to reduce a total trip distance of equipment utilized to treat a number of wellsites relative to treating the wellsites from the base facility (facilities) of the various treating equipment. Yet another example logistics facility is positioned to reduce a total trip distance of equipment utilized to treat a number of wellsites, where the wellsites are distributed in more than one continuous field of wellsite locations.

As used herein, the term “binding agent” should be understood broadly. A binding agent includes any material tending to cause the solid particle species to retain a solid body shape under the conditions provided by a consolidating device. In certain embodiments, a specific binding agent may not be required, and one or more of the solid particle species or an additive to the wellbore treatment fluid precursor may inherently include an agent acting as a binding agent. In certain embodiments, any binding agent and/or industrial binding agent is contemplated herein. In certain embodiments, without limitation, a binding agent includes any one or more of the materials (or solutions thereof) selected from: corn syrup, glycerin, a sugar, tar, bitumen, wax, lignin, cement, clay, lime, water, a polyol, a poly-ether, polyethylene glycol, a water soluble polymer, a resin, a polymer, a phosphate, and/or a sodium silicate.

As used herein, the term “wellbore treatment fluid viscosifying agent” should be understood broadly. Any viscosifying agent utilized in a wellbore treatment application is contemplated herein. Non-limiting examples include hydratable gels (e.g., guars, poly-saccharides, xanthan, diutan, hydroxy-ethyl-cellulose, etc.), a cross-linked hydratable gel and/or a cross-linking agent, an acid viscosifying agent, an emulsion promoting agent (e.g., one or more surfactants), an agent promoting viscosification in an energized fluid (e.g., a surfactant), a viscoelastic surfactant (VES), a gelling or foaming agent, and/or a precursor material of any one or more of the foregoing materials. A precursor for a particular material is any material that, upon further reaction, dissolution, hydrolysis or other process releases or forms as a reaction product the particular material.

As used herein, the term “particle species” should be understood broadly. Any type of particle having a distinct size, range of sizes, and/or composition is contemplated as a particle species herein. In one example, two particle species are considered to have distinct particle sizes if each of the two particle species includes a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In certain embodiments, one or more of the particle species are formed in conjunction with a consolidation operation, for example as a precipitate of a fluid that is dehydrated during the consolidation operation. In certain embodiments, the particle species are substantially spherical. In some certain embodiments, the particle species are not substantially spherical. For example, a particle species may have an aspect ratio, defined as the ratio of the longest dimension of the particle to the shortest dimension of the particle, of more than 2, 3, 4, 5 or 6. Examples of such non-spherical particles include, but are not limited to, fibers, flakes, discs, rods, stars, etc. In certain embodiments, such as but not limited to when a particle species is defined by the particle composition, the shape and/or size of the particle species may be irregular and/or not relevant. In some embodiments, the particle species of the current application are substantially stable and do not change shape or form over an extended period of time, temperature, or pressure; in some other embodiments, the particle(s) or particulate(s) of the current application are degradable, dissolvable, deformable, meltable, sublimeable, or otherwise capable of being changed in shape, state, or structure. All such variations should be considered within the scope of the current application.

As used herein, the term “additive” should be understood broadly. Any substances utilized in a wellbore treatment fluid, and precursors thereof, may be an additive. Without limitation, a wellbore treatment fluid viscosifying agent, a crosslinking agent, a crosslink delaying agent, a proppant flowback control agent, a pH control agent (acid, base, or buffer), a proppant, a particle provided for scouring purposes, a fluid loss control agent, a clay control agent, an acid stabilization and/or metal corrosion protection agent, a biocide, a surfactant, a wetting agent, and/or a breaker is contemplated as an additive herein.

As used herein, the term “pump ready” should be understood broadly. In certain embodiments, a pump ready treatment fluid means the treatment fluid is fully prepared and can be pumped downhole without being further processed. In some other embodiments, the pump ready treatment fluid means the fluid is substantially ready to be pumped downhole except that a further dilution may be needed before pumping or one or more minor additives need to be added before the fluid is pumped downhole. In such an event, the pump ready treatment fluid may also be understood to be a pump ready treatment fluid precursor. In some further embodiments, the pump ready treatment fluid may be a fluid that is substantially ready to be pumped downhole except that certain incidental procedures are applied to the treatment fluid before pumping, such as low-speed agitation, heating or cooling under exceptionally cold or hot climate, etc.

Referencing FIG. 1, an illustration 100 of example solid bodies 102 are schematically depicted. The solid bodies 102 in the example are similarly sized and shaped to a brick, providing a solid body 102 that is convenient to quantify, store, transport, and to handle upon reconstitution. Any size and shape of a solid body 102 is contemplated herein. Without limitation, the shape may be selected according to a shape conveniently formed by a consolidation device, a shape convenient for storage, transportation, metering, dissolution, packing, handling, consolidation and/or reconstitution. Examples of shapes include, without limitation, blocks, spheres, cylinders, fibers, rods, polyhedrons, briquettes, random shapes, and/or mixtures thereof. Any one or more of the shapes may be provided with grooves, holes, cavities, indentations, or any other feature. Without limitation, the size may be selected according to a size conveniently formed by a consolidation device, a size convenient for storage and/or transport, a size convenient for handling upon reconstitution, and/or a size selected to provide a given amount of wellbore treatment fluid for a given number (or amount, e.g., by weight) of solid bodies 102 and/or a size selected to provide a convenient reconstitution ratio of carrier fluid amount to number of solid bodies 102. The size may be understood to include a weight and/or volume description of the solid bodies 102. The solid bodies 102 may be uniformly sized or irregularly sized, and likewise may be uniformly shaped or irregularly shaped.

Example and non-limiting sizes of a solid body 102 include at least 1 cm³, at least 10 cm³, at least 100 cm³, at least 1,000 cm³, and at least 5,000 cm³. In certain embodiments, a solid body 102 may be smaller than 1 cm³, or larger than 10,000 cm³. Additionally or alternatively, the solid bodies 102 may be sized according to weight. Example and non-limiting weights of a solid body 102 include at least 2 g, at least 20 g, at least 200 g, at least 2 kg, and at least 10 kg. In certain embodiments, a solid body 102 may be smaller than 2 g, or larger than 20 kg. In certain additional or alternative embodiments, each solid body 102 is provided within a volume range. Example and non-limiting volume ranges include between 0.1 mm³ and 0.5 mm³ inclusive, between 0.5 mm³ and 50 mm³ inclusive, between 50 mm³ and 1000 mm³ inclusive, between 1000 mm³ and 5000 mm³ inclusive, between 5 cm³ and 100 cm³ inclusive, between 100 cm³ and 1000 cm³ inclusive, between 1000 cm³ and 5000 cm³ inclusive, and between 1000 cm³ and 10,000 cm³. Other ranges, including ranges between the described ranges, greater than the described ranges, or smaller than the described ranges are also contemplated herein. In certain embodiments, each of the solid bodies 102 includes a shortest dimension (such as a minor axis of an aspect ratio) that is not less than 2 mm. In certain embodiments, each of the solid bodies 102 includes at least 10 discrete members of the solid particle species.

Each of the solid bodies 102 includes a substantially similar average composition, and further includes at least one solid particle species and an additive. In certain embodiments, each of the solid bodies 102 includes at least two solid particle species. In certain embodiments, each of the solid bodies 102 includes at least three solid particle species. In certain embodiments, each of the solid bodies 102 includes at least four solid particle species. Further example solid bodies 102 may include any number of solid particle species. In certain embodiments, each of the solid bodies 102 comprises more than one mode of dispersed particles, hence a “multimodal particles” system. As used herein multimodal particles refers to a plurality of particle sizes or modes which each have a distinct size or particle size distribution. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In certain embodiments, the particles contain a bimodal mixture of two particles; in certain other embodiments, the particles contain a trimodal mixture of three particles; in certain additional embodiments, the particles contain a tetramodal mixture of four particles; in certain further embodiments, the particles contain a pentamodal mixture of five particles. Examples of multimodal particles systems that can be used in the current application have been disclosed in U.S. Pat. No. 5,518,996, U.S. Pat. No. 7,004,255, U.S. Pat. No. 7,784,541, U.S. Pat. No. 7,833,947, US20100300688, U.S. Pat. No. 7,923,415, US20120000651, US20120000641, U.S. Pat. No. 8,119,574, the contents of which are hereby incorporated by reference in their entireties.

In certain embodiments, each of the solid bodies 102 further includes a binding agent. In certain embodiments, one of the solid particle species includes a wellbore treatment fluid viscosifying agent. In certain embodiments, one of the solid particle species includes one or more of the following materials: a gelling agent, a friction reducer, a biocide, a scale inhibitor, a dissolution-based precursor material, a temperature-based precursor material, a chemical reaction-based precursor material, a hydration-based precursor material, an encapsulated precursor material, a proppant material, a proppant flowback control material, a proppant transport aid, a clay stabilizer, and/or a breaker.

In certain embodiments, the solid bodies 102 include a particle and/or additive having a swelling property. A swelling property indicates that the particle or additive increases in volume (e.g., has a volume increase characteristic) while in fluid contact with a specific fluid and/or a group of specific fluids. The volume increase may be through any mechanism, including without limitation absorption, adsorption, and/or repulsive forces generated in the system of the particle/additive with the fluid. A particle or additive having a swelling property increases in volume while in contact with the one or more specific fluids, which can assist in breaking apart solid bodies 102, and/or assist in breaking apart or mixing remaining portions of the solid bodies 102 as the solid bodies 102 experience a dimensional reduction.

The specific fluid may be any fluid known to induce swelling in an additive or particle. Example fluids include water, oil, or certain gases. Example and non-limiting materials having a swelling property in the presence of water include crosslinked polysaccharides, for example crosslinked guar and its derivatives, crosslinked alginate and its derivatives, crosslinked or noncrosslinked cellulose and its derivatives; crosslinked polyols, for example polyvinyl alcohols; crosslinked polyacrylamides; water swellable clays, for example bentonite; silica gel; and certain cement particles. An example material including a swelling property in the presence of water includes a water swellable elastomer composition. Another example material having a swelling property in the presence of a liquid includes a particle having an osmotic membrane, wherein the particle and a reconstituting fluid are selected to cause osmotic pressure to expand the particle. The osmotic expansion may be designed to occur with or without ultimate rupture of the osmotic membrane.

Example and non-limiting materials having a swelling property in the presence of oil, which may include any hydrocarbon, crude oil, alcohol, and/or organic compounds, include elastomer thermoplastics, ground rubber, acrylate butadiene rubber, polyacrylate rubber, isoprene rubber, choloroprene rubber, butyl rubber, brominated butyl rubber, chlorinated butyl rubber, chlorinated polyethylene, neoprene rubber, styrene butadiene block copolymer, sulphonated polyethylene, ethylene acrylate rubber, ethylene-propylene rubber, ethylene vinyl acetate copolymer, fluorosilicone rubber, silicone rubber, etc. More examples can be found in European Patent Application EP1764374, which is hereby incorporated by reference in the entirety for all purposes.

Example and non-limiting materials having a swelling property in the presence of a gas include various carbon materials that expand in the presence of gaseous hydrocarbons such as methane. Example and non-limiting materials include triblock copolymer Styrene-Isoprene-Styrene (SIS) or triblock copolymer Styrene-Butadiene-Styrene (SBS), such as those disclosed in WO2012022399A1 and EP2450417A1, the entire contents of which are incorporated herein by reference in the entirety for all purposes.

An example includes the solid bodies 102 having a material including a swelling property. An example procedure utilizing the solid bodies 102 having the material including the swelling property includes an operation to add a specific fluid to the carrier fluid during the reconstituting operation. Example specific fluids include carbon dioxide, nitrogen (e.g., as air or as a nitrogen enriched stream via membrane operations or pressure-swing adsorption), water, water having a specific constituent dissolved therein either below or above a threshold value (e.g., to induce osmotic pressure buildup in the material including the swelling property), and/or a hydrocarbon. In certain embodiments, the carrier fluid is the specific fluid and/or includes the specific fluid. Example procedures further include reducing a dimension of the solid bodies 102, and/or at least partially breaking up the solid bodies 102 to expose or increase a surface area of exposure of the material including the swelling property to the specific fluid, and/or to enhance a mass transfer environment between the material including the swelling property and the specific fluid. The material including the swelling property, in certain embodiments, is the solid particle species, the additive and/or the binding agent within the solid bodies 102.

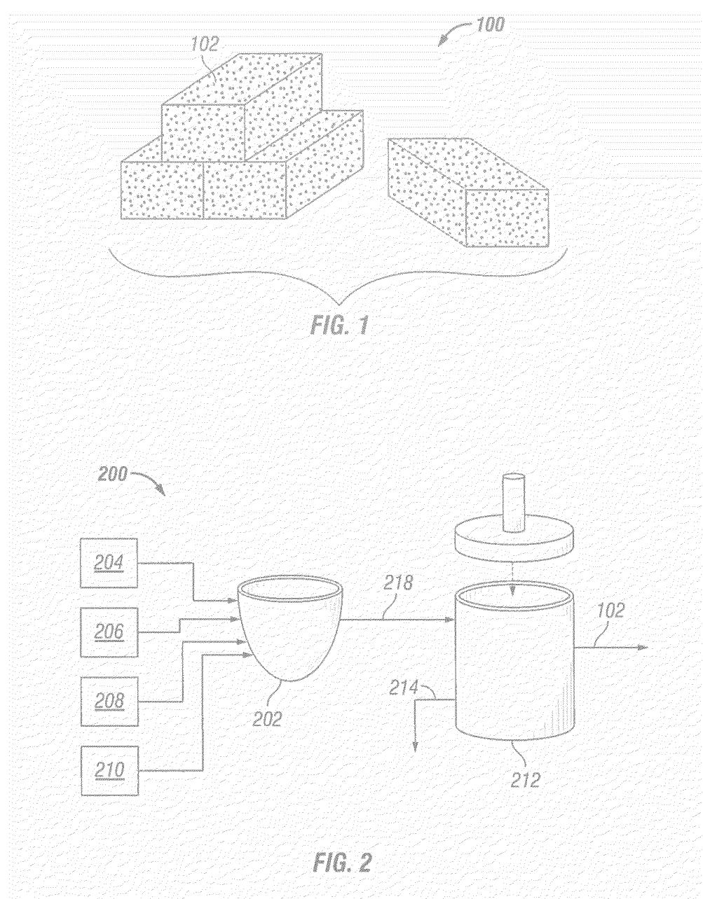

Referencing FIG. 2, a system 200 includes a first solid particle species source 204. The system 200 further includes a second solid particle species source 206 and a binding agent source 208. The system 200 illustrates a separate binding agent source 208, although in certain embodiments the binding agent source 206 may be included with or inherent to one or both of the solid particle species sources 204, 206 and/or a carrier fluid source 210. In certain embodiments, the system 200 includes the carrier fluid source 210, for example providing an amount of a carrier fluid to hydrate one of the particle species before a consolidation operation. The inclusion of a carrier fluid source 210 is optional and non-limiting.

The system 200 further includes a mixing vessel 202. The mixing vessel 202 is operationally coupled to the first and second particle species sources 204, 206, and provides a mixed effluent 218. The mixed effluent 218 includes the first particle species and the second particle species in a defined ratio. The mixing vessel 202 is illustrated as a batch mixing vessel, although the mixing vessel 202 may be any type of mixing vessel known in the art, including at least a continuous flow mixing region of a process that mixes material from the first particle species source 204 and the second particle species source 206 in a defined ratio. The system 200 may be controlled to any degree of precision desired, including by measured weights in a batch process, a computer controlled continuous process, or any other control mechanism known in the art. The details of any such operation are known and are not further described to promote clarity in the present description.

The system 200 includes a consolidation device 212 that receives the mixed particle effluent 218 and consolidates the mixed particle effluent 218 into a number of solid bodies 102 each having a substantially similar average composition. The illustrated consolidation device 212 illustrates a pressure vessel having an effluent purge stream 214. However, any type of consolidation device 212 is contemplated herein. Example and non-limiting consolidation devices include a heater, a dryer, an evaporator, a centrifuge, a sound or vibration device, an electromagnetic radiation device, a radiation device, a device for delivering radiant energy to the mixed particle effluent, and/or a press. A consolidation device 212 may include multiple stages. The consolidation device 212 may further include additional processing elements, for example a cutting device that separates a consolidated mass into the solid bodies 102.

The system 200, in certain embodiments, provides advantages over previously known wellbore treatment fluid formation techniques and systems. The described advantages are illustrative and non-limiting, and certain embodiments of the system 200 may have some, none or all of the described advantages. The system 200, in certain embodiments, is provided at a location that is able to be provided at an arbitrary distance, shipping time, and shipping method (e.g., train, truck, boat, airplane, etc.) from a final wellsite location where a treatment operation utilizing a wellbore treatment fluid formulated using the solid bodies will occur. Accordingly, the location of the system 200 is not constrained by any of the limitations inherent to oilfield locations, including limited space on location and the inconvenience of transporting precision measurement equipment to the location. The provided solid bodies 102 can be provided with an arbitrary level of mixing precision, and the equipment to manufacture the solid bodies is not subjected to transport, including the inherent size limitations and potential damage occurring therefrom. Additionally, personnel operating the system 200 are not subjected to transport or required to move from location to location.

Further, the solid bodies 102 can be provided to bypass limitations occurring from previously known systems to provide wellbore treatment fluids. For example, where an expensive chemical is included in a treatment at a wellsite in minute amounts, previously known applications required that a high precision pump or other delivery method be available at the wellsite. Small operational errors occurring at the wellsite can significantly impact the usage of the expensive chemical. The system 200 allows the formation of the solid bodies 102 to include any chemical diluted within, with arbitrary precision, such that small operational errors occurring at the wellsite do not have a significant impact even for chemicals that are only included in minute amounts. Further, the solid bodies 102 have a much greater shelf life and portability than liquid and/or slurried products, even where the liquid or slurried products are highly concentrated. Solid phase chemicals are also generally more inert, having a subsequently longer holding time and lower spill impact than liquid and/or slurried products.

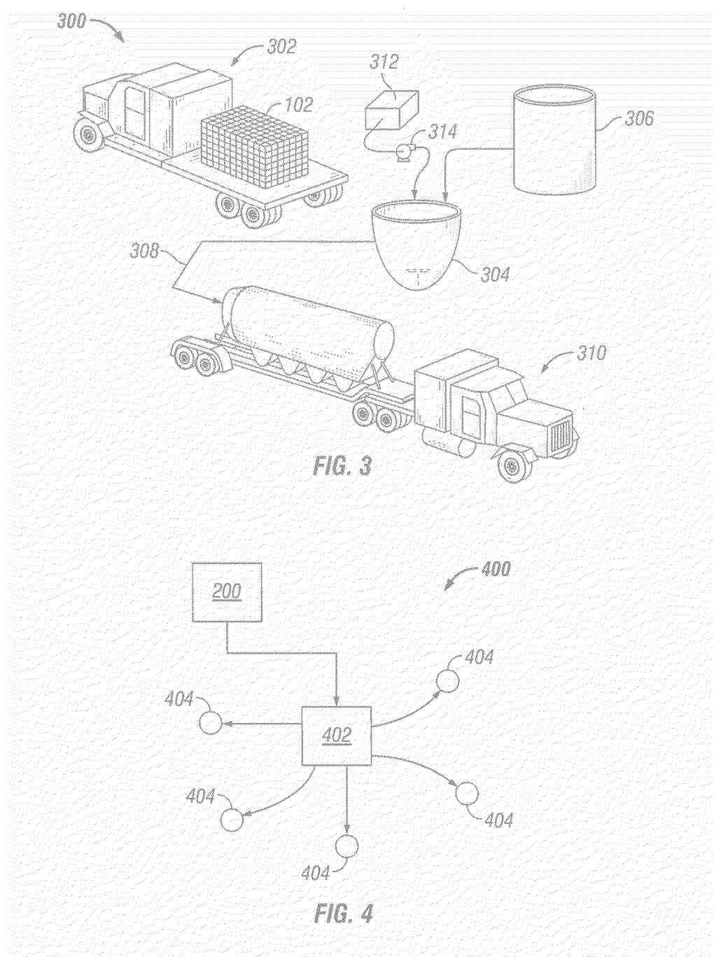

Referencing FIG. 3, a reconstitution system 300 is schematically depicted according to some embodiments of the present application. The system 300 includes a delivery vehicle 302 having a number of solid bodies 102. The delivery vehicle 302 is depicted as a truck, but may be any transport device known in the art. In certain embodiments, the solid bodies 102 are held at the location of the system 200, and after a storage period are provided to a reconstitution system 300 without being transported to a different location. The system 300 includes a reconstituting device 304, illustrated as an agitator. The reconstituting device 304 may be any device that is capable of mixing the solid bodies 102 and a carrier fluid 306 into a wellbore treatment fluid and/or a concentrated wellbore treatment fluid. Non-limiting examples of a reconstituting device 304 include a mixer, a grinder, a mill, a chopper, a blender and/or a heater. In certain embodiments, the reconstituting device 304 further includes an additive delivery pump 314 and a source for an additive or supplemental agent 312. The supplemental agent 312 may be a releasing agent (e.g., an acid, solvent, CO₂, etc.) that interacts with, reacts with, dissolves, and/or induces swelling in the solid bodies 102 or a constituent in the solid bodies 102. In certain embodiments, the additive or supplemental agent 312 is an additive desired to be present in the wellbore treatment fluid 308, and may include any additives known in the art.

The reconstituting device 304 mixes a carrier fluid 306 with the solid bodies 102 to form a concentrated wellbore treatment fluid 308 (or a wellbore treatment fluid 308). In the example system 300, a transport truck 310 receives the concentrated wellbore treatment fluid 308 for final delivery to a wellsite location. At the wellsite location, the concentrated wellbore treatment fluid 308 is mixed with a further amount of a carrier fluid (the same or a distinct carrier fluid from the carrier fluid 306) and/or one or more additives and provided to a high pressure pump. In certain embodiments, the system 300 is provided at a logistics facility (see the description referencing FIG. 4). Reconstitution, as used herein, is an indication that a consolidated solid body 102 is mixed with fluid and is a fluid or slurry having a continuous phase. The materials in the reconstituted fluid or slurry may be the same as or distinct from, the materials in the particle species and the additive. Accordingly, reconstituted may include, but does not need to include, a return to a previous fluid state for the solid bodies 102.

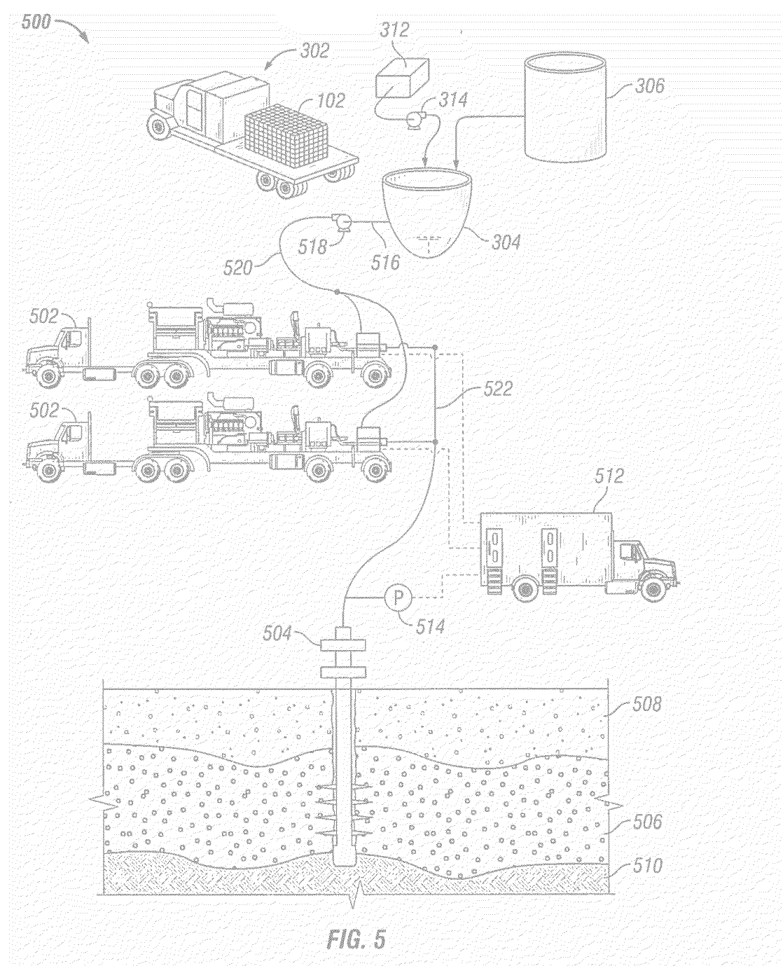

In certain embodiments, the reconstituting device 304 provides a wellbore treatment fluid that can be provided directly to a high pressure pump. Referencing FIG. 5, a system 500 includes the reconstituting device 304 providing a wellbore treatment fluid 516 which is the reconstituted fluid. In the example of FIG. 5, a low pressure pump 518 delivers the pressurized fluid 520 to high pressure pumps 502. In certain embodiments, the fluid 516 may be delivered by hydrostatic head to the pumps 502, and/or a blender (not shown) may be present in the system 500. In certain embodiments, the wellbore treatment fluid 516 and/or concentrated wellbore treatment fluid includes an amount of proppant, such that proppant is not separately required to be present at the wellsite location. In certain embodiments, the wellbore treatment fluid 516 and/or concentrated wellbore treatment fluid is gelled and hydrated, and a continuous mixer (e.g., a Precision Continouous Mixer—PCM) and/or a fracturing blender (e.g., a Programmable Optimum Density—POD blender) is not required to be present at the wellsite location. The system 500 includes the high pressure line to the wellhead 504, where the wellhead is fluidly coupled to a formation of interest 506. An overburden 508 and formation 510 below the formation of interest 506 are illustrated in the system 500. A control vehicle 512 is in communication with various equipment in the system 500, including for example a pressure sensor 514. Various details of the system 500 are provided as an example and are non-limiting. For example, the wellbore may be deviated and/or horizontal, and the completion may be open hole or cased. The treatment fluid 516 may be provided in various stages, which may be provided by a scheduled progression of solid bodies 102 of various types and/or concentrations within the treatment fluid 516.

In certain embodiments, more than one type of solid body 102 is present, where each individual type of solid body includes the solid bodies of the type each having a substantially similar average composition, at least one solid particle species for treating a subterranean formation, and at least one additive, and where the solid particle species and the additive are present in a defined ratio within the type of solid body. Where two or more types of solid bodies are present, the location of addition of each type of solid body may be the same or distinct. For example, two types of solid bodies may both be reconstituted into a treatment fluid at a pilot plant, both reconstituted at a wellbore, or one reconstituted at the pilot plant and the other reconstituted at the wellbore. The compositional requirement defining a substantially similar average composition may be the same or distinct for each of the solid body types. For example, the compositional requirement of a first solid body type may be sensitive and require a composition within 1% to be substantially similar, where the compositional requirement of a second solid body type may be less sensitive and require a composition within 10% to be substantially similar, even where the two solid body types are utilized to create the same final wellbore treatment fluid.

In certain embodiments, the number of solid bodies is solid bodies of a first type, and the article further includes a second number of solid bodies of a second type. The solid bodies of the second type are solid bodies each having a substantially similar average composition, each having at least one solid particle species for treating a subterranean formation and at least one additive. The solid particle species and the additive are present in each of the solid bodies of the second type in a defined ratio. The substantially similar average composition of the first type of solid bodies is distinct from the substantially similar average composition of the second type of solid bodies.

In certain embodiments, the solid bodies 102 including a substantially similar composition are non-uniform and/or non-homogenous solid bodies 102. For example, the solid bodies 102 may be a layered material, a laminated material, a coated material, an encapsulated material or other compositional form that provides solid bodies having a substantially similar composition with a non-uniform and/or non-homogenous form factor. In certain embodiments, a laminated and/or layered solid body is formed by providing a substrate formed of the laminated and/or layered material, and separating the substrate (e.g., cutting) into the solid bodies. Any other processes to form layered, laminated, coated and/or encapsulated solid bodies is contemplated herein.

In certain embodiments, the solid bodies 102 are coated, encapsulated, wrapped or otherwise protected after formation. Where a solid body is protected after formation, solid bodies in protected form may or may not include a substantially similar average composition, although the unprotected solid bodies remain having a substantially similar average composition. The protective material may increase stability, storability, protect the solid bodies from environmental effects, prevent volatile materials from evaporating out of the solid bodies or perform any other function. The protective material may be removed before formation of the wellbore treatment fluid, for example through agitation, dissolution, heating, etc., and/or the protective material may be included in the formed wellbore treatment fluid.

Referencing FIG. 4, a schematic representation 400 shows a system 200 and a logistics facility 402. The system 200, in the example of FIG. 4, is a production facility for solid bodies 102. The production facility may be at an arbitrary distance from the logistics facility 402, including without limitation 10 miles, 100 miles, 1000 miles, or further from the logistics facility 402. In certain embodiments, the system 200 is not on the same landmass as the logistics facility 402. The logistics facility 402 includes storage facilities for solid bodies 102 and/or includes one or more reconstituting devices 304. In certain embodiments, solid bodies 102 are transported directly to wellsites 404 from the logistics facility 402, the solid bodies 102 are reconstituted at the logistics facility 402 and transported to wellsites 404 as concentrated wellbore treatment fluids, and/or the solid bodies 102 are reconstituted at the logistics facility 402 and transported to the wellsites 404 as wellbore treatment fluids.

A first non-limiting example illustrating certain aspects of the present application is described following. A multi-particle blend was prepared by measuring out various solid particulates including natural sands, minerals and polymeric materials. These solid particles were then mixed with an overhead paddle mixer to homogenize the particles. A sample of the dry blend was removed and checked for quality and consistency by hydrating the mixture with water and then testing the slurry with a Couette coaxial cylinder viscometer (e.g., Fann 35). Several aliquots (˜350 mL) of the dry solid blend were then taken and thoroughly mixed with 30 mL of a binding agent (several samples with corn syrup and others with glycerin). Each of the dampened blends was then separately placed into a metal frame 2″ by 4″ with a movable piston on the bottom. The top of the frame was closed and secured with the material inside and a 4 ton press was used to move the bottom cylinder and apply 1000 psi to compact the mixture. After several seconds at full pressure, the press was released and the solid material was removed from the mold and had the appearance of a brick with dimensions of approximately 2″ wide, 4″ long, and 1.5″ tall. The bricks of consolidated solid particles were then placed into an oven set to 110° F. for 48 hours. After removing the samples from the oven they were stored as solid bricks and could be handled without significant de-agglomeration or breakage. After 5 days in storage the samples were then manually broken with a hammer into smaller pieces no larger than 0.33″ diameter and an appropriate volume of water was added to each sample. Each sample was stirred by hand with a metal spatula to ensure complete hydration and homogenization of the slurry and then measured using a Couette coaxial cylinder viscometer. Each of the re-hydrated/reconstituted samples was found to have a similar quality to the original sample before the agglomeration and compaction process.

A second non-limiting example illustrating certain aspects of the present application is described following. A multi-particle blend was prepared by measuring out various solid particulates including natural sands, minerals and polymeric materials. These solid particles were then mixed with an overhead paddle mixer to homogenize the particles. A sample of the dry blend was removed and checked for quality and consistency by hydrating the mixture with water and then testing the slurry with a Couette coaxial cylinder viscometer (e.g., Fann 35). Several 100 mL aliquots of this slurry were then weighed as they were placed into uncapped 250 mL beakers and placed in an oven set at 110° F. for 48 hours. After removing the samples from the oven they were re-weighed to confirm a consistent loss of water. Each sample was a solid mass that could be handled and did not break. Each sample was stored for three days at room temperature. At this time, the appropriate volume of water was added to each sample and they were placed in air tight containers to limit evaporation. Each sample was allowed to hydrate for five days without intervention. On the fifth day each sample was stirred by hand with a metal spatula to ensure complete hydration and homogenization of the slurry and then they were measured using a Couette coaxial cylinder viscometer. Each of the re-hydrated/reconstituted samples was found to have a similar quality to the original sample before the dehydration/rehydration process.

A third non-limiting example illustrating certain aspects of the present application is described following. A multi-particle blend was prepared by measuring out various solid particulates including natural sands, minerals and polymeric materials. These solid particles were then mixed with an overhead paddle mixer to homogenize the particles. Several aliquots of the dry solid blend were then taken and thoroughly mixed with various amounts of anhydrous citric acid powder, followed by 30 mL of a binding agent (several samples with corn syrup and others with glycerin). Each of the dampened blends was then separately placed into a metal frame 2″ by 4″ with a movable piston on the bottom. The top of the frame was closed and secured with the material inside and a 4 ton press was used to move the bottom cylinder and apply 1000 psi to compact the mixture. After several seconds at full pressure, the press was released and the solid material was removed from the mold and had the appearance of a brick with dimensions of approximately 2″ wide, 4″ long, and 1.5″ tall. The bricks of consolidated solid particles were then placed into an oven set to 110° F. for 48 hours. After removing the samples from the oven they were stored as solid bricks and could be handled without significant de-agglomeration or breakage. After 2 days in storage the samples were then re-hydrated with a known volume of water. The samples were observed to have a chemical reaction as the citric acid within the solid agglomeration was hydrated and reacted with other solid chemicals in the blend to produce carbon dioxide gas. This action aided in the deconsolidation of the solid brick and allowed for quicker and easier homogenization of the samples into a consistent slurry.

An example procedure for providing a wellbore treatment fluid precursor as a solid consolidated body is described following. The procedure includes an operation to prepare a wellbore treatment fluid precursor including at least one solid particle species and a binding agent. The procedure further includes an operation to consolidate the wellbore treatment fluid precursor into a number of solid bodies, each one of the solid bodies having a substantially similar average composition. In certain embodiments, the procedure includes providing the at least one solid particle species at a defined amount or ratio therebetween.

In certain embodiments, the procedure further includes an operation to form a wellbore treatment fluid, where the forming operation includes adding one or more of the solid bodies to a carrier fluid, and providing the wellbore treatment fluid to a high pressure pump fluidly coupled to a wellbore. In certain embodiments, the wellbore treatment fluid is a treatment slurry, for example including proppant. In certain embodiments, the forming the wellbore treatment fluid is performed after an intermediate storage time. Example and non-limiting intermediate storage times include one day, three days, one week, one month and one year.

The example procedure further includes reducing a dimension of the added solid bodies. Reducing includes breaking down the solid form of the solid bodies in any dimension. Example and non-limiting operations to reduce a dimension of the solid bodies include chemically dissolving at least a portion of the added solid bodies, applying a pressure to the added solid bodies, applying a temperature to the added solid bodies, agitating the added solid bodies, mechanically assisting the breakup of the added solid bodies, blending the added solid bodies, milling the added solid bodies, exposing the added solid bodies to a binding agent solvent, and/or providing the solid body with a reactive agitation agent. Example and non-limiting reactive agitation agents include an agent that generates a gas, for example carbon dioxide gas, in the carrier fluid thereby assisting the breakup of the solid body.

In certain embodiments, the procedure includes an operation to measure the amount of the added solid bodies to the carrier fluid. The measuring operation includes counting the number of solid bodies, weighing the added amount of the solid bodies and/or determining a volume of the added amount of solid bodies to the carrier fluid. In certain embodiments, the procedure includes an operation to dissolve one or both of the solid particle species into the carrier fluid. Certain example operations to consolidate the wellbore treatment fluid precursor include removing liquid from the wellbore treatment fluid precursor, dehydrating the wellbore treatment fluid precursor, vaporizing a portion of the wellbore treatment fluid precursor, applying a lowered pressure to the wellbore treatment fluid precursor, reducing the temperature of the wellbore treatment fluid precursor, positioning the wellbore treatment fluid precursor in fluid communication with a dessicant, heating the wellbore treatment fluid precursor, pressurizing the wellbore treatment fluid precursor, applying electromagnetic energy to the wellbore treatment fluid precursor (such as microwave, infrared, radiofrequency), applying radiation to the wellbore treatment fluid, applying sound waves, ultrasound wave, and/or vibration to the wellbore treatment fluid, allowing the wellbore treatment fluid to coalesce, allowing the wellbore treatment fluid to crystallize, allowing the wellbore treatment fluid to polymerize, applying an energy source to the wellbore treatment fluid precursor, and/or applying mechanical force to the wellbore treatment fluid precursor.

In certain embodiments, the procedure includes an operation to form a concentrated wellbore treatment fluid. The operation to form the concentrated wellbore treatment fluid includes adding one or more solid bodies to a carrier fluid, and providing the concentrated wellbore treatment fluid to a transport vessel and/or a storage vessel. Additionally or alternatively, the procedure includes an operation to form a wellbore treatment fluid, where the forming the wellbore treatment fluid further includes adding an additional amount of the carrier fluid to the concentrated wellbore treatment fluid. In certain embodiments, the procedure includes an operation to transport the concentrated wellbore treatment fluid from a logistics facility to a surface location for a wellbore before the forming the wellbore treatment fluid.

While the disclosure has provided specific and detailed descriptions to various embodiments, the same is to be considered as illustrative and not restrictive in character. Only certain example embodiments have been shown and described. Those skilled in the art will appreciate that many modifications are possible in the example embodiments without materially departing from the disclosure. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

We claim:

1. A method, comprising:
preparing a wellbore treatment fluid precursor comprising at least one solid particle species and at least one additive; and
consolidating the wellbore treatment fluid precursor into a plurality of solid bodies, each one of the solid bodies having an substantially similar average composition.

2. The method of claim 1, further comprising adding a binding agent to the wellbore treatment fluid precursor before the consolidating.

3. The method of claim 1, further comprising forming a wellbore treatment fluid, the forming comprising adding at least one of the solid bodies to an amount of a carrier fluid, and providing the wellbore treatment fluid to a high pressure pump fluidly coupled to a wellbore.

4. The method of claim 3, wherein the forming further comprises independently dispersing a solid particle species product and an additive product into the wellbore treatment fluid, the solid particle species product comprising one of the solid particle species and a solid particle species successor and the additive product comprising one of the additive and an additive successor.

5. The method of claim 3, further comprising:
adding a binding agent to the wellbore treatment fluid precursor before the consolidating; and
reducing a dimension of the added solid bodies, wherein the reducing comprises at least one operation selected from the operations consisting of: chemically dissolving at least a portion of the added solid bodies, applying a pressure to the added solid bodies, applying an energy source to the added solid bodies, agitating the added solid bodies, mechanically assisting the breakup of the added solid bodies, blending the added solid bodies, milling the added solid bodies, exposing the added solid bodies to a binding agent solvent, and providing the solid body with a reactive agitation agent.

6. The method of claim 3, wherein the forming further comprises measuring the amount of the added solid bodies, the measuring comprising at least one quantization operation selected from the quantization operations consisting of: counting the number of solid bodies, weighing the amount of solid bodies, and determining a volume of the amount of solid bodies.

7. The method of claim 3, wherein the forming further comprises dissolving at least one of the solid particle species.

8. The method of claim 1, wherein the consolidating comprises at least one of the consolidation operations selected from the operations consisting of: allowing the wellbore treatment fluid to coalesce, allowing the wellbore treatment fluid to crystallize, allowing the wellbore treatment fluid to polymerize, removing liquid from the wellbore treatment fluid precursor, dehydrating the wellbore treatment fluid precursor, vaporizing a portion of the wellbore treatment fluid precursor, applying a lowered pressure to the wellbore treatment fluid precursor, positioning the wellbore treatment fluid precursor in fluid communication with a dessicant, applying an energy source to the wellbore treatment fluid precursor, pressurizing the wellbore treatment fluid precursor, and applying mechanical force to the wellbore treatment fluid precursor.

9. The method of claim 1, further comprising forming a concentrated wellbore treatment fluid, wherein the forming a concentrated wellbore treatment fluid comprises adding at least one of the solid bodies to an amount of a carrier fluid, and providing the concentrated wellbore treatment fluid to one of a transport vessel and a storage vessel.

10. The method of claim 9, further comprising forming a wellbore treatment fluid, the forming the wellbore treatment fluid comprising adding an additional amount of the carrier fluid to the concentrated wellbore treatment fluid.

11. The method of claim 10, further comprising transporting the concentrated wellbore treatment fluid from a logistics facility to a surface location for a wellbore.

12. The method of claim 4, wherein forming the wellbore treatment fluid is performed after an intermediate storage time elapses, the intermediate storage time comprising one of the time values selected from the time values consisting of: one day, three days, one week, one month, and one year.

13. The method of claim 1, wherein the preparing the wellbore treatment fluid precursor further comprises adding a material including a swelling property to the wellbore treatment fluid before the consolidating, wherein the swelling property comprises a volume increase characteristic in response to a specific fluid.

14. The method of claim 13, further comprising forming a wellbore treatment fluid, the forming comprising adding at least one of the solid bodies to an amount of a carrier fluid, wherein the adding further comprises exposing the material including the swelling property to the specific fluid.

15. An article of manufacture, comprising:
a plurality of solid bodies, each of the solid bodies having a substantially similar average composition, each of the solid bodies comprising at least one solid particle species for treating a subterranean formation and at least one additive, and wherein the solid particle species and the additive are present in a defined ratio.

16. The article of manufacture of claim 15, wherein each of the solid bodies further comprises a binding agent.

17. The article of manufacture of claim 16, wherein the binding agent comprises at least one material selected from the group of materials consisting of: corn syrup, glycerin, polyethylene glycol, a poly-ether, a water soluble polymer, a sugar, tar, bitumen, wax, lignin, cement, clay, lime, water, a polyol, a resin, a polymer, a phosphate, and a sodium silicate.

18. The article of manufacture of claim 15, wherein each of the solid bodies further comprises a material having a swelling property, wherein the swelling property comprises a volume increase characteristic in response to a specific fluid.

19. The article of manufacture of claim 18, wherein the material having the swelling property comprises at least one material selected from the materials consisting of: a water absorbing material, a gas absorbing material, a gas generating material, a carbonate, an encapsulated pressurized gas, a CO₂ absorbing material, a nitrogen absorbing material, a hydrocarbon absorbing material, a methane absorbing material, an oil absorbing material, and an osmotic material.

20. The article of manufacture of claim 15, wherein the solid particle species comprises at least one material selected from the group of materials consisting of: a wellbore treatment fluid viscosifying agent, a gelling agent, a friction reducer, a biocide, a scale inhibitor, a dispersant, an emulsifier, a nonemulsifier, a surfactant, a pH modifier, an anti-settling agent, a dissolution-based precursor material, a temperature-based precursor material, a chemical reaction-based precursor material, a hydration-based precursor material, an encapsulated precursor material, a proppant material, a proppant flowback control material, a clay stabilizer, and a breaker.

21. The article of manufacture of claim 15, wherein the solid bodies each comprise a volume range selected from the ranges consisting of: between 0.1 mm³ and 0.5 mm³ inclusive, between 0.5 mm³ and 50 mm³ inclusive, between 50 mm³ and 1000 mm³ inclusive, between 1000 mm³ and 5000 mm³ inclusive, between 5 cm³ and 100 cm³ inclusive, between 100 cm³ and 1000 cm³ inclusive, between 1000 cm³ and 5000 cm³ inclusive, and between 1000 cm³ and 10,000 cm³.

22. The article of manufacture of claim 15, wherein the solid bodies each have a shortest dimension of not less than 2 mm.

23. The article of manufacture of claim 15 wherein the solid bodies each include at least ten discrete members of the solid particle species.

24. The article of manufacture of claim 15, wherein the plurality of solid bodies comprise solid bodies of a first type, the article further comprising a second plurality of solid bodies of a second type, the second pluralities of the solid bodies each having a substantially similar average composition, each comprising at least one solid particle species for treating a subterranean formation and at least one additive, wherein the solid particle species and the additive are present in each of the solid bodies of the second plurality of solid bodies in a defined ratio, and wherein the substantially similar average composition of the first type of solid bodies is distinct from the substantially similar average composition of the second type of solid bodies.

25. A system, comprising:
a solid particle species source for treating a subterranean formation;
an additive source;
a binding agent source;
a mixing vessel operationally coupled to the particle species source, the additive source, and the binding agent source, and structured to provide a mixed particle effluent having the particle species and the additive in a defined ratio; and
a consolidation device structured to receive the mixed particle effluent, and to consolidate the mixed particle effluent into a plurality of solid bodies each having a substantially similar average composition.

26. The system of claim 25, further comprising a reconstituting device structured to mix a carrier fluid with the plurality of solid bodies, and to provide a pump ready treatment fluid.

27. The system of claim 26, wherein the consolidation device is positioned at a production facility and wherein the reconstituting device is positioned at one of a wellsite and a logistics facility.

28. The system of claim 26, wherein the reconstituting device comprises at least one device selected from the devices consisting of an agitator, a mixer, a grinder, a mill, a chopper, a blender, a heater, a device for delivering radiant energy to the solid bodies, and an additive delivery pump.

29. The system of claim 26, wherein the reconstituting device is further structured to mix a releasing agent with the carrier fluid and the plurality of solid bodies.

30. The system of claim 25, wherein the consolidation device comprises at least one device selected from the list of devices consisting of: a heater, a dryer, an evaporator, a centrifuge, a sound device, a vibration device, an electromagnetic radiation device, a radiation device, a device for delivering radiant energy to the mixed particle effluent, and a press.

31. The system of claim 24, wherein the solid particle species comprises a wellbore treatment fluid viscosifying agent.
